(19) United States
(12) Patent Application Publication
(10) Pub. No.: US 2021/0036448 A1
(43) Pub. Date: Feb. 4, 2021

(54) CONNECTOR

(71) Applicant: JAPAN AVIATION ELECTRONICS INDUSTRY, LIMITED, Tokyo (JP)

(72) Inventor: Tomohiro NAKAMURA, Tokyo (JP)

(73) Assignee: JAPAN AVIATION ELECTRONICS INDUSTRY, LIMITED, Tokyo (JP)

(21) Appl. No.: 16/922,331

(22) Filed: Jul. 7, 2020

(30) Foreign Application Priority Data
Jul. 30, 2019 (JP) 2019-140071

(51) Int. Cl. H01R 12/71; H01R 13/24; H01R 13/502

(52) U.S. Cl. CPC H01R 12/714; H01R 33/97; H01R 13/502; H01R 13/2442

(57) ABSTRACT

In a connector, a cover is attached to a base member by use of a hinge mechanism. First, second and third contact rows are arranged in decreasing order of distance from the hinge mechanism. The first, the second and the third contact rows have first contacts, second contacts and third contacts, respectively. Each of the first contacts and the second contacts has a held portion held by the base member, a contact point and a spring portion extending from the held portion and supporting the contact point. The contact points of the first contacts and the contact points of the second contacts face one another in a front-rear direction. As viewed along an up-down direction, the contact points and the spring portions of the first contacts and the contact points and the spring portions of the second contacts are visible when the cover is positioned in an open position.

### CROSS REFERENCE TO RELATED APPLICATIONS

This application is based on and claims priority under 35 U.S.C. § 119 to Japanese Patent Application No. JP2019-140071 filed Jul. 30, 2019, the contents of which are incorporated herein in their entirety by reference.

### BACKGROUND OF THE INVENTION

This invention relates to a connector, in particular, to a connector which is connectable to a card-type device.

JP 2003-142184A (Patent Document 1) discloses an example of the so-called hinge-type card connector. As shown in FIG. 9, a card connector 90 of Patent Document 1 has a base plate 92 and a card holder 94 attached to the base plate 92. The card holder 94 is openable and closable with respect to the base plate 92.

As understood from FIG. 9, the card connector 90 of Patent Document 1 is connectable to two cards (or card-type devices) 96. The card holder 94 is provided with holder contacts 942 to be brought into contact with surface contacts 962 of one of the cards 96. Moreover, the base plate 92 is provided with two rows of front base contacts 922 to be brought into contact with surface contacts 962 of the remaining one of the cards 96 and a row of rear base contacts 924 to be brought into contact with holder contacts 942.

### SUMMARY OF THE INVENTION

Since the card connector 90 of Patent Document 1 is formed to accommodate the two cards 96 and to juxtapose the cards 96 in their thickness direction, a size of the card connector 90 is large in an up-down direction when the card connector 90 is in a closed state. Accordingly, there is a demand to integrate functions of the two cards 96 into one card-type device and thereby reducing a height of the connector. Here, in order to respond to this demand, structure of each of contacts and arrangement of the contacts become big problems according to the number of the contacts.

It is therefore an object of the present invention to provide a connector which is a hinge-type connector connectable to a card-type device and capable of reducing its height.

One aspect of the present invention provides a connector connectable to a card-type device as a first connector. The connector comprises a first contact row, a second contact row, a third contact row, a base member and a cover. The base member is provided with a hinge mechanism at one of end portions of the base member in a front-rear direction. The cover is movably attached to the base member by means of the hinge mechanism. The first contact row, the second contact row and the third contact row are held by the base member so at to be arranged in decreasing order of distance from the hinge mechanism in the front-rear direction. Each of the first contact row, the second contact row and the third contact row has a plurality of contacts. Each of the contacts of the first contact row and the contacts of the second contact row has a held portion held by the base member, a contact point, and a spring portion extending from the held portion and supporting the contact point. The contact points of the contacts of the first contact row and the contact points of the contacts of the second contact row face one another in the front-rear direction. As viewed along an up-down direction perpendicular to the front-rear direction, the contact points and the spring portions of the first contact row and the contact points and the spring portions of the second contact row are visible when the cover is positioned in an open position.

In the connector according to the aspect of the present invention, the contact points of the contacts of the first contact row and the contact points of the contacts of the second contact row face to one another. Moreover, regarding the contacts of the first contact row and the contacts of the second contact row, the contact points of them and the spring portions of them are visible when the cover is in the open position as viewed along the up-down direction. With this structure, the connector can be reduced in height, and it can be prevented that the card-type device is brought into abutment with the contacts of the second contact row and buckles the contacts of the second contact row when the card-type device is improperly inserted into the connector.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a perspective view showing a connector according to an embodiment of the present invention. A cover of the connector is positioned in an open position.

FIG. 2 is another perspective view showing the connector of FIG. 1. The cover holds a card-type device.

FIG. 3 is yet another perspective view showing the connector of FIG. 1. The cover is positioned in a closed position.

FIG. 4 is still another perspective view showing the connector of FIG. 1. The cover is positioned in a locked position.

FIG. 5 is a plan view showing the connector of FIG. 3.

FIG. 6 is a plan view showing a connector body included in the connector of FIG. 4.

FIG. 7 is a perspective view showing a second contact included in the connector of FIG. 1.

FIG. 8 is another plan view showing the connector body of FIG. 5. The card-type device is accommodated in an accommodating portion of the connector body in a state that the cover is detached from the connector.

FIG. 9 is a perspective view showing a card connector disclosed in Patent Document 1. Two cards capable of being accommodated in the card connector are shown together with the card connector.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DESCRIPTION OF PREFERRED EMBODIMENTS

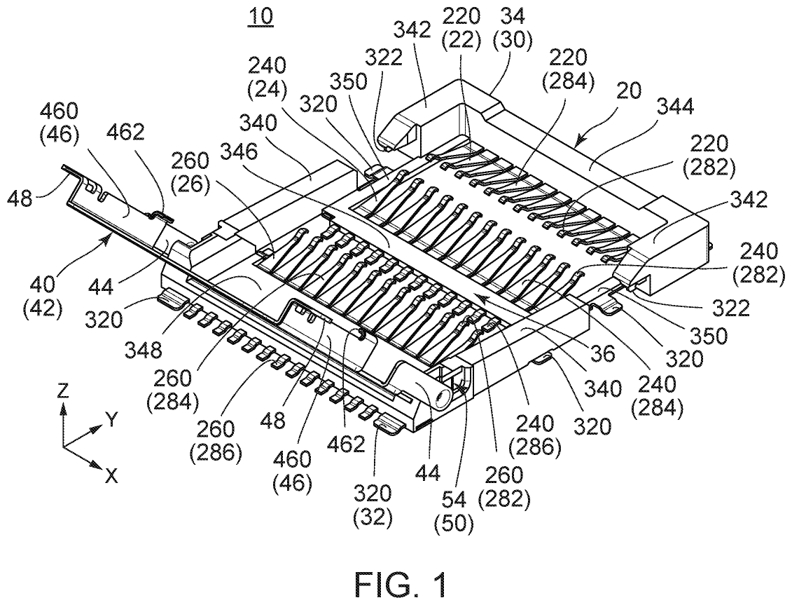

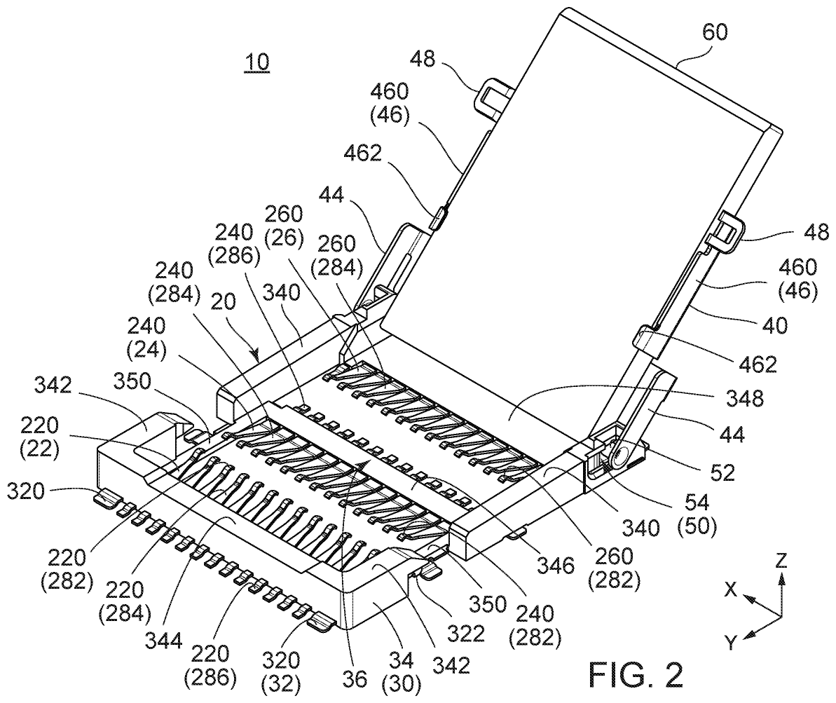

Referring to FIGS. 1 and 2, a connector 10 according to an embodiment of the present invention is provided with a connector body (connector) 20 and a cover 40. The cover 40 is movably attached to the connector body 20 by means of a hinge mechanism 50. The connector 10 is connectable to a card-type device 60.

As understood from FIGS. 1 and 2, the hinge mechanism 50 is provided to one of end portions of the connector body 20 in a front-rear direction. In the present embodiment, the front-rear direction is a Y-direction. A positive Y-direction is directed forward while a negative Y-direction is directed rearward. The hinge mechanism 50 is provided to a rear end portion of the connector body 20 in the present embodiment.

As understood from FIGS. 1 to 5, the hinge mechanism 50 consists of axis portions 52 provided to the cover 40 and axis receiving portions 54 provided to the connector body 20. However, the present invention is not limited thereto. The hinge mechanism 50 may consist of axis portions provided to the connector body 20 and axis receiving portions provided to the cover 40.

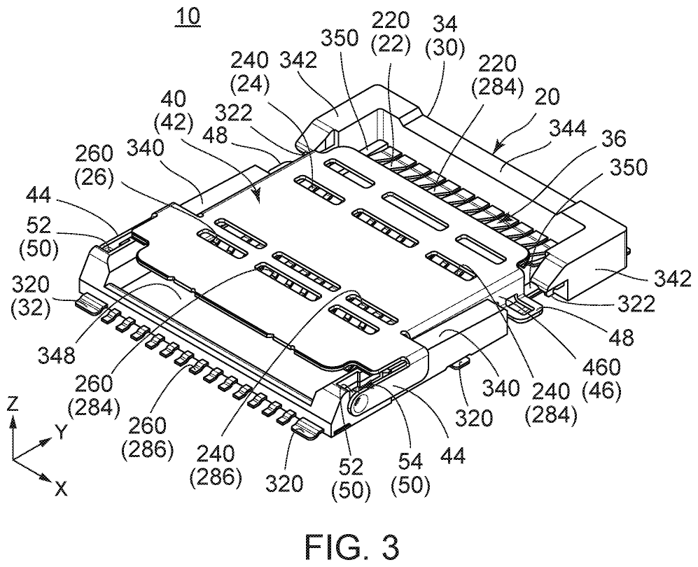

As understood from FIGS. 1 to 4, the axis receiving portions 54 receive the axis portions 52, respectively, at least in part to allow the axis portions 52 to be turned. Accordingly, the cover 40 is pivotable on the axis portions 52 as a pivot with respect to the connector body 20. In other words, the cover 40 is openable and closable with respect to the connector body 20. In detail, the cover 40 is pivotable with respect to the connector body 20 between an open position shown in FIG. 1 or 2 and a closed position shown in FIG. 3.

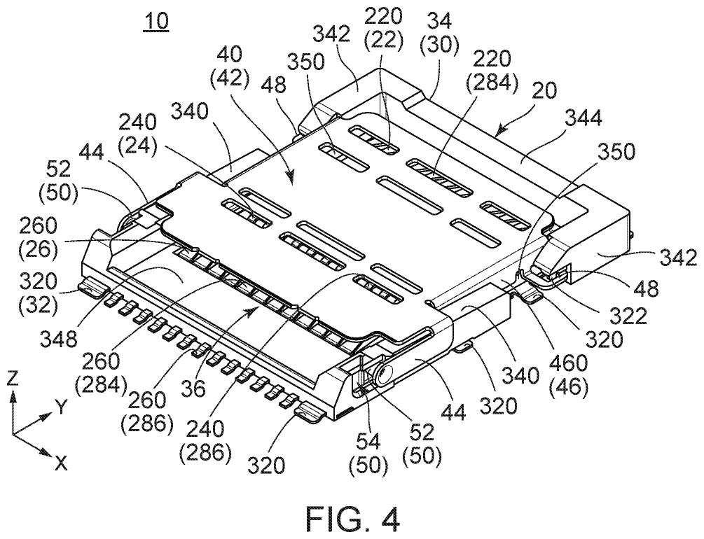

As understood from FIGS. 3 and 4, the axis receiving portions 54 allow the axis portions 52 to be moved within a predetermined range in the front-rear direction. Accordingly, the cover 40 is movable with respect to the connector body 20 within the predetermined range in the front-rear direction. In detail, the cover 40 is movable between the closed position shown in FIG. 3 and a locked position shown in FIG. 4 in the front-rear direction. Additionally, the cover 40 is pivotable with respect to the connector body 20 within a necessary range to carry out a lock operation and an unlock operation while it is moved between the closed position and the locked position.

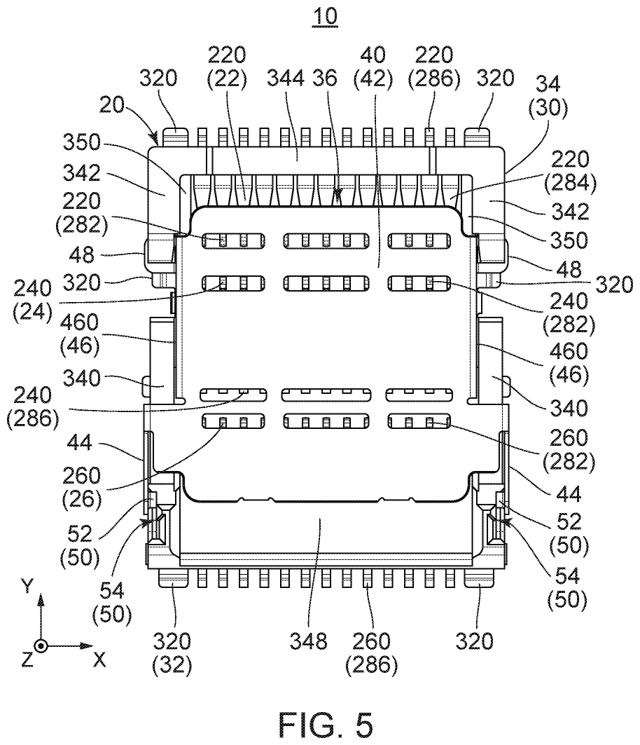

As shown in FIGS. 1 to 5, the cover 40 has a main plate portion 42, a pair of arm portions 44, a pair of card holding portions 46 and a pair of locked portions 48. The main plate portion 42 has a roughly rectangular shape. When the cover 40 is in the closed position (see FIG. 3) or the locked position (see FIGS. 4 and 5), the arm portions 44 are located at both sides of the main plate portion 42 in a lateral direction perpendicular to the front-rear direction and at the same position as a rear part of the main plate portion 42 in the front-rear direction. When the cover 40 is in the closed position or the locked position, the arm portions 44 extend downward in an up-down direction perpendicular to both of the front-rear direction and the lateral direction and then extend rearward. The arm portions 44 are respectively provided with the axis portions 52 at their end parts. In the present embodiment, the lateral direction is an X-direction. And, the up-down direction is a Z-direction. A positive Z-direction is directed upward while a negative Z-direction is directed downward.

As understood from FIGS. 1 to 5, the card holding portions 46 of the cover 40 are located at both sides of the main plate portion 42 in the lateral direction and located forward of the arm portions 44 in the front-rear direction. Each of the card holding portions 46 has a side plate 460 and a holding piece 462. When the cover 40 is positioned in the closed position (see FIG. 3) or the locked position (see FIGS. 4 and 5), the side plate 460 protrudes downward. And, a holding piece 462 protrudes inward in the lateral direction from a lower end of the side plate 460.

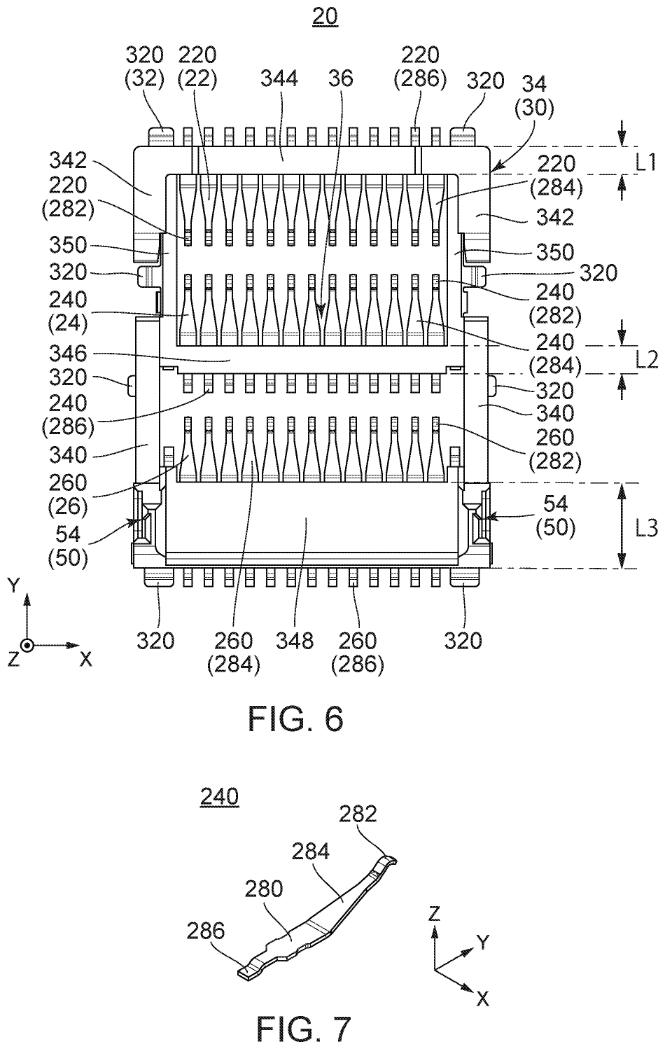

As understood from FIGS. 1 and 2, when the cover 40 is positioned in the open position, the card-type device 60 can be inserted from diagonally above the cover 40 between the main plate portion 42 and the holding pieces 462 and between the side plates 460 so as to be loosely held by the cover 40. As understood from FIGS. 1 to 3, when the cover 40 is moved between the open position and the closed position, the card-type device 60 is moved together with the cover 40. As understood from FIGS. 3, 4 and 8, when the cover 40 is positioned in the closed position or the locked position, the card-type device 60 is accommodated in a card accommodation portion 36 (see FIG. 6). When the cover 40 is moved between the closed position and the locked position, the card-type device 60 is not moved substantially.

As shown in FIGS. 3 to 5, when the cover 40 is positioned in the closed position or the locked position, the locked portions 48 of the cover 40 protrude outward in the lateral direction from front end portions of the side plates 460 of the card holding portions 46. Each of the locked portions 48 is provided with an opening which pierces the locked portion 48 in the up-down direction when the cover 40 is positioned in the closed position or the locked position. The locked portions 48 form a locking mechanism in conjunction with lock portions 332 provided to a base member 30 mentioned later. The locked portions 48 regulate direct movement of the cover 40 from the locked position to the open position by engaging with the lock portions 322, respectively.

As shown in FIGS. 1, 2 and 6, the connector body 20 is provided with a first contact row 22, a second contact row 24, a third contact row 26 and the base member 30. The base member 30 holds the first contact row 22, the second contact row 24 and the third contact row 26. The first contact row 22, the second contact row 24 and the third contact row 26 are arranged and are distant from the hinge mechanism 50 in the front-rear direction in this order.

As understood from FIGS. 1, 2 and 6, the base member 30 has a frame 32 and a resin portion 34. The frame 32 has a plurality of fixed portions 320 and the pair of the lock portions 322. The frame 32 is made of a single or plural metal plates. The resin portion 34 has a pair of rear sidewalls 340, a pair of front sidewalls 342, a front wall 344, a middle bottom plate 346, a rear bottom plate 348 and a pair of side bottom plates 350. The resin portion 34 is made of insulating resin and integrally formed with the first contact row 22, the second contact row 24, the third contact row 26 and the frame 32. The base member 30 defines the card accommodation portion 36 which accommodates the card-type device 60.

As shown in FIG. 6, the rear sidewalls 340 extend in the front-rear direction and are arranged in the lateral direction so as to be parallel with each other and apart from each other. Each of the rear bottom plate 348 and the middle bottom plate 346 connects the rear sidewalls 340 to each other. The front sidewalls 342 extend in the front-rear direction and are arranged in the lateral direction so as to be parallel with each other and apart from each other. The front sidewalls 342 are respectively arranged forward of the rear sidewalls 340 and apart from the rear sidewalls 340. The side bottom plates 350 connect the front sidewalls 342 to the rear sidewalls 340, respectively. Moreover, the side bottom plates 350 connect the middle bottom plate 346 to the front wall 344. The front wall 344 extends in the lateral direction and connects the front sidewalls 342 to each other.

As shown in FIG. 6, the front wall 344 holds the first contact row 22. The middle bottom plate 346 holds the second contact row 24. The rear bottom plate 348 holds the third contact row 26. Thus, the front wall 344, the middle bottom plate 346 and the rear bottom plate 348 are a first holding portion 344, a second holding portion 346 and a third holding portion 348 which hold the first contact row 22, the second contact row 24 and the third contact row 26, respectively.

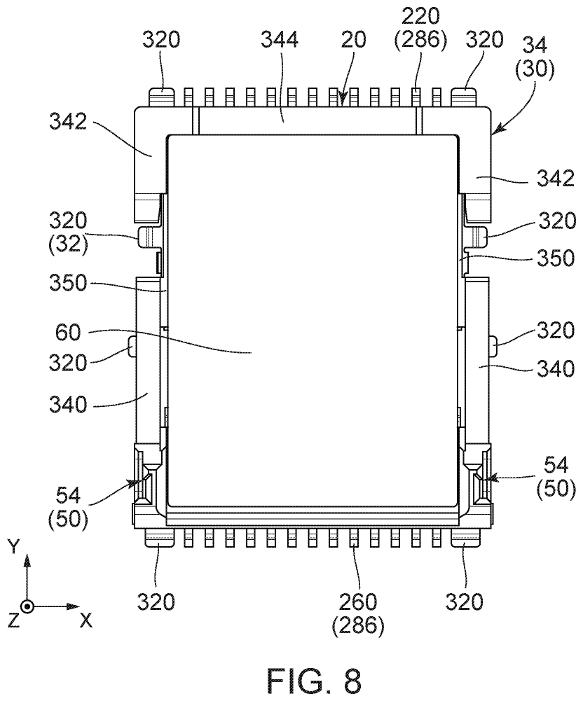

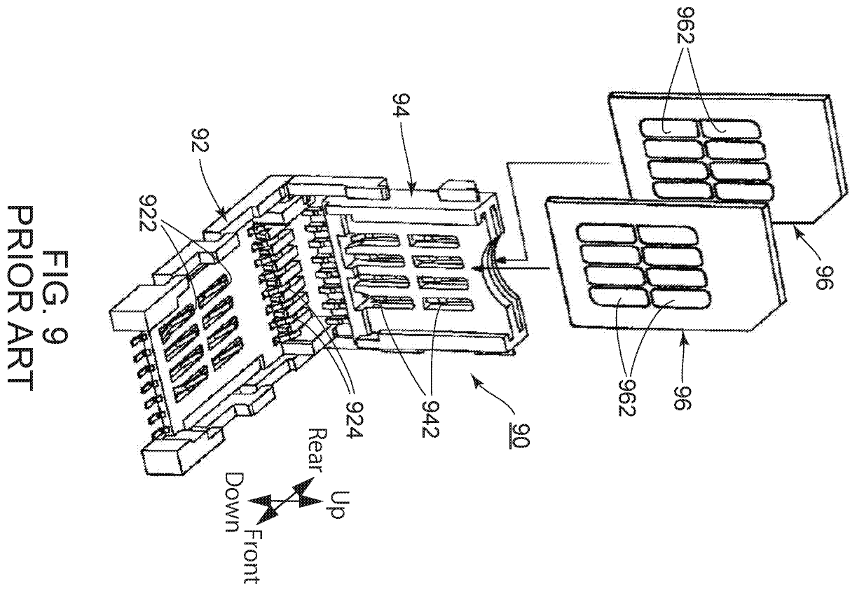

As understood from FIG. 6, the first contact row 22 consists of a plurality of first contacts 220. The second contact row 24 consists of a plurality of second contacts 240. The third contact row 26 consists of a plurality of third contacts 260. The first contacts 220 are arranged at regular intervals in the lateral direction. The same applies to the second contacts 240 and the third contacts 260. In the present embodiment, each of the number of the first contacts 220, the number of the second contacts 240 and the number of the third contacts 260 is thirteen. However, the present invention is not limited thereto. The number and the arrangement of the first contacts 220, the number and the arrangement of the second contacts 240 and the number and the arrangement of the third contacts 260 are decided according to the number and the arrangement of card contact points (not shown) provided to the card-type device 60 (see FIG. 2 or 8).

As understood from FIG. 6, the first contacts 220 have the same shape and the same size as one another. The same applies to the second contacts 240 and the third contacts 260. In the present embodiment, the first contact 220 and the second contact 240 have the same shape and the same size as each other. The third contact 260 has a similar shape similar to that of the first contact 220 or the second contact 240, but it has a different size different from that of the first contact 220 or the second contact 240. However, the present invention is not limited thereto. The first contact 220 may be different from the second contact 240 at least one of in shape and in size. The third contact 260 may have the same shape and the same size as the first contact 220 or the second contact 240.

As understood from FIG. 7, each of the second contacts 240 has a held portion 280, a contact point 282, a spring portion 284 and a fixed portion 286. Similarly, each of the first contacts 220 and the third contacts 260 has a held portion 280, a contact point 282, a spring portion 284 and a fixed portion 286.

As understood from FIGS. 6 and 7, the held portion 280 is held by the resin portion 34. The contact point 282 is brought into contact with the card contact point (not shown) provided to the card-type device 60 (see FIG. 2 or 8). The spring portion 284 extends from the held portion 280 and supports the contact point 282. The fixed portion 286 extends from the held portion 280 in a direction opposite to an extending direction of the spring portion 284. The fixed portion 286 is fixed to a mount surface (not shown), such as a surface of a circuit board, by soldering when the connector 10 is mounted on the mount surface.

As understood from FIGS. 1, 2, 6 and 7, the spring portion 284 is formed as a cantilever and resiliently deformable. In detail, the spring portion 284 extends forward or rearward in the front-rear direction and extends upward in the up-down direction perpendicular to both of the front-rear direction and the lateral direction. The spring portion 284 supports the contact point 282 so that the contact point 282 is movable at least in the up-down direction. Since the spring portion 284 is formed as the cantilever, the spring portion 284 can provide moving amount necessary for the contact point 282 and necessary reaction force even if the size of the spring portion 284 is small in the up-down direction. Thus, size reduction can be made for the first contacts 220, the second contacts 240 and the third contacts 260, and the connector body 20 can be reduced in height.

As understood from FIGS. 1, 2 and 6, as viewed along the up-down direction, the contact point 282 and the whole of the spring portion 284 of each of the first contacts 220, the second contacts 240 and the third contacts 260 are visible when the cover 40 is positioned in the open position. In other words, the connector body 20 has no protecting portion covering the spring portion 284 from above and beneath. Accordingly, the connector 10 can be further reduced in height.

As shown in FIG. 6, the spring portions 284 of the first contacts 220 extend rearward in the front-rear direction. On the other hand, the spring portions 284 of the second contacts 240 extend forward in the front-rear direction. Thus, the spring portions 284 of the first contacts 220 and the spring portions 284 of the second contacts 240 extend so as to face one another. As a result, the contact points 282 of the first contacts 220 and the contact points 282 of the second contacts 240 face one another in the front-rear direction. This structure allows an interval between the contact point 282 of the first contact 220 and the contact point 282 of the second contact 240 to reduce irrespective of a length of the spring portion 284 of the first contact 220 and a length of the spring portion 284 of the second contact 240. In other words, this structure can meet a case where an interval between card contact points (not shown) of the card-type device 60 (see FIG. 2 or 8) becomes narrower.

As shown in FIG. 6, the spring portions 284 of the third contacts 260 extend forward in the front-rear direction. According to this structure, when the card-type device 60 (see FIG. 2 or 8) is improperly inserted into the connector 10 or when the card-type device 60 is not inserted into the cover 40 appropriately, it can be prevented that the card-type device 60 buckles the spring portions 284 of the third contacts 260. In detail, as understood from FIGS. 1 and 2, when the card-type device 60 fails to be inserted into the cover 40 and is not held by the cover 40, a front edge of the card-type device 60 slides forward in the card accommodation portion 36. Since the spring portions 284 of the third contacts 260 extend forward in the front-rear direction, they are pressed down by the front edge of the card-type device 60 without resistance to the front edge of the card-type device 60 and resiliently deformed. Thus, the spring portions 284 of the third contacts 260 allow the card-type device 60 to be moved without resistance to the card-type device 60. Therefore, the spring portions 284 of the third contacts 260 are prevented from being buckled.

As shown in FIG. 6, the spring portions 284 of the second contacts 240 extend forward in the front-rear direction similarly to the spring portions 284 of the third contacts 260. According to this structure, in addition to the spring portions 284 of the third contacts 260, the spring portions 284 of the second contacts 240 are prevented from being buckled when the card-type device 60 (see FIG. 2 or 8) is improperly inserted into the connector 10 or when the card-type device 60 fails to be inserted into the cover 40.

As shown in FIG. 6, in the front-rear direction, the second contacts 240 are located between free ends of the spring portions 284 of the first contacts 220 and free ends of the spring portions 284 of the third contacts 260. Accordingly, the second contacts 240 are not restricted by positions of the fixed portions 286 of the first contacts 220 and positions of the fixed portion 286 of the third contacts 260. Therefore, the second contacts 240 can be lengthened in length in the front-rear direction.

As shown in FIG. 6, the front wall (the first holding portion) 344, which holds the held portions 280 of the first contacts 220, has a size of L1 in the front-rear direction. The middle bottom plate (the second holding portion) 346, which holds the held portions 280 of the second contacts 240, has a size of L2 in the front-rear direction. The rear bottom plate (the third holding portion) 348, which holds the held portions 280 of the third contacts 260, has a size of L3 in the front-rear direction. In the present embodiment, an equation L1=L2 holds. Moreover, in the present embodiment, an inequality L3>L1, L2 holds. However, the present invention is not limited thereto. The size of L1 and the size of L2 may be different from each other. The size of L3 may be equal to the size of L1 or the size of L2. Nevertheless, it is preferable that the size of L3 is larger than each of the size of L1 and the size of the L2. This is because the rear bottom plate 348 is a part with which the front edge of the card-type device 60 (see FIG. 2 or FIG. 8) is brought into abutment when the card-type device 60 is inserted into the cover 40 and helpful in preventing the card-type device 60 from being brought into abutment with the third contacts 260 when the card-type device 60 fails to be held by the cover 40.

As mentioned above, the connector 10 according to the present embodiment can be reduced in height by forming each of the spring portions 284 of the first contacts 220, the second contacts 240 and the third contacts 260 as the cantilever and by making the contact point 282 and the spring portion 284 of each of the first contacts 220, the second contacts 240 and the third contacts 260 visible. In addition, the spring portions 284 of the second contacts 240 extend forward similarly to the spring portions 284 of the third contacts 260. This prevents buckling of not only the third contacts 260 but the second contacts 240 when the card-type device 60 is inserted into the connector 10 in an inappropriate manner.

Although the specific explanation about the present invention is made above referring to the embodiments, the present invention is not limited thereto but susceptible of various modifications and alternative forms without departing from the spirit of the invention. For example, although the connector 10 according to the present embodiment is constructed for the card-type device 60 having a rectangular shape, it may be constructed for another card-type device having a shape other than the rectangular shape, e.g., a shape with a cutaway portion. Moreover, each of the hinge mechanism 50 and the locking mechanism may be freely designed in structure.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A connector connectable to a card-type device, wherein:
the connector comprises a first contact row, a second contact row, a third contact row, a base member and a cover;
the base member is provided with a hinge mechanism at one of end portions of the base member in a front-rear direction;
the cover is movably attached to the base member by means of the hinge mechanism;
the first contact row, the second contact row and the third contact row are held by the base member so as to be arranged in decreasing order of distance from the hinge mechanism in the front-rear direction;
each of the first contact row, the second contact row and the third contact row has a plurality of contacts;
each of the contacts of the first contact row and the contacts of the second contact row has a held portion held by the base member, a contact point, and a spring portion extending from the held portion and supporting the contact point;
the contact points of the contacts of the first contact row and the contact points of the contacts of the second contact row face one another in the front-rear direction; and
as viewed along an up-down direction perpendicular to the front-rear direction, the contact points and the spring portions of the first contact row and the contact points and the spring portions of the second contact row are visible when the cover is positioned in an open position.

2. The connector as recited in claim 1, wherein:
each of the contacts of the third contact row has a held portion held by the base member, a contact point and a spring portion extending from the held portion and supporting the contact point; and
the spring portions of the contacts of the third contact row extend in a same direction as the spring portions of the contacts of the second contact row.

3. The connector as recited in claim 1, wherein:
the base member has a first holding portion, a second holding portion and a third holding portion which hold the first contact row, the second contact row and the third contact row, respectively; and
in the front-rear direction, a size of the third holding portion is larger than each of a size of the first holding portion and a size of the second holding portion.
